(19) United States
(12) Patent Application Publication
(10) Pub. No.: US 2014/0133584 A1
(43) Pub. Date: May 15, 2014

(54) BLUETOOTH DEVICE AND RELATED COMMUNICATIONS ESTABLISHING METHOD

(71) Applicant: MEDIATEK INC., Hsin-Chu (TW)

(72) Inventors: Wei-Kun Su, Taipei City (TW); Huanchun Ye, Cupertino, CA (US)

(73) Assignee: MEDIATEK INC., Hsin-Chu (TW)

(21) Appl. No.: 13/957,451

(22) Filed: Aug. 2, 2013

Related U.S. Application Data
(60) Provisional application No. 61/725,093, filed on Nov. 12, 2012.

(51) Int. Cl. H04B 5/00

(52) U.S. Cl. CPC H04B 5/00
USPC 375/256

(57) ABSTRACT

A communications establishing method for a Bluetooth system includes: setting a first Bluetooth apparatus to use an out-of-band channel to pair with a second Bluetooth apparatus when the second Bluetooth apparatus intends to pair with the first Bluetooth apparatus; and enabling an enhanced page-scanning mechanism in the first Bluetooth apparatus to scan a channel used by the second Bluetooth apparatus for transmitting an ID packet of the second Bluetooth apparatus when the first Bluetooth apparatus is paired with the second Bluetooth apparatus via the out-of-band channel.

### CROSS REFERENCE TO RELATED APPLICATIONS

This application claims the benefit of U.S. Provisional Application No. 61/725,093, which was filed on 2012 Nov. 12 and is included herein by reference.

### BACKGROUND

The present invention relates to a Bluetooth device and related communications establishing method, and more particularly to a method and related device for establishing communications between a master Bluetooth device and a slave Bluetooth device in an efficient way.

In a conventional Bluetooth system, when a master Bluetooth device needs to establish communications with a slave Bluetooth device, a user should first manually pair the master Bluetooth device with the slave Bluetooth device. To pair the master Bluetooth device with the slave Bluetooth device, the master Bluetooth device may need to find out all slave Bluetooth devices which are located near the master Bluetooth device, and then needs to select one of the slave Bluetooth devices for pairing. It is time-consuming, however, for the user to determine a desired slave Bluetooth device when there are many slave Bluetooth devices on the candidate list.

After the master Bluetooth device is paired with the slave Bluetooth device, the master Bluetooth device enters the page state to page the slave Bluetooth device, and the slave Bluetooth device enters the page scan state to scan the channel of the master Bluetooth device. Conventionally, the slave Bluetooth device listens on one of 32 channels for at least 10 ms, and a different channel is selected every 1.28 seconds. As the slave Bluetooth device may randomly select one of the 32 channels to listen for the master Bluetooth device, the slave Bluetooth device may fail to match the channel used by the master Bluetooth device. Consequently, the user will waste time waiting for the paging process between the master Bluetooth device and the slave Bluetooth device. Providing a more efficient way to establish communications between the master Bluetooth device and the slave Bluetooth device is an urgent problem in the field of Bluetooth systems.

### SUMMARY

One of the objectives of the present embodiment is to provide a method and related device for establishing communications between a master Bluetooth device and a slave Bluetooth device in a more efficient way.

According to a first embodiment of the present invention, a communications establishing method for Bluetooth system is provided. The communications establishing method comprises: setting a first Bluetooth apparatus to use an out-of-band channel to pair with a second Bluetooth apparatus when the second Bluetooth apparatus intends to pair with the first Bluetooth apparatus; and enabling an enhanced page-scanning mechanism in the first Bluetooth apparatus to scan a channel used by the second Bluetooth apparatus for transmitting an ID packet of the second Bluetooth apparatus when the first Bluetooth apparatus is paired with the second Bluetooth apparatus via the out-of-band channel.

According to a second embodiment of the present invention, a Bluetooth apparatus is provided. The Bluetooth apparatus comprises an out-of-band device and a page-scanning device. The out-of-band device is arranged to use an out-of-band channel to pair with a specific Bluetooth apparatus when the specific Bluetooth apparatus intends to pair with the Bluetooth apparatus. The page-scanning device is arranged to enable an enhanced page-scanning mechanism to scan a channel used by the specific Bluetooth apparatus for transmitting an ID packet of the specific Bluetooth apparatus when the Bluetooth apparatus is paired with the specific Bluetooth apparatus via the out-of-band channel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a Bluetooth system having a first Bluetooth apparatus and a second Bluetooth apparatus according to a first embodiment of the present invention.

FIG. 2 is a flowchart illustrating a communications establishing method for a first Bluetooth apparatus and a second Bluetooth apparatus according to a second embodiment of the present invention.

FIG. 3 is a flowchart illustrating a communications establishing method for a first Bluetooth apparatus and a second Bluetooth apparatus according to a third embodiment of the present invention.

FIG. 4 is a flowchart illustrating a communications establishing method for a first Bluetooth apparatus and a second Bluetooth apparatus according to a fourth embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

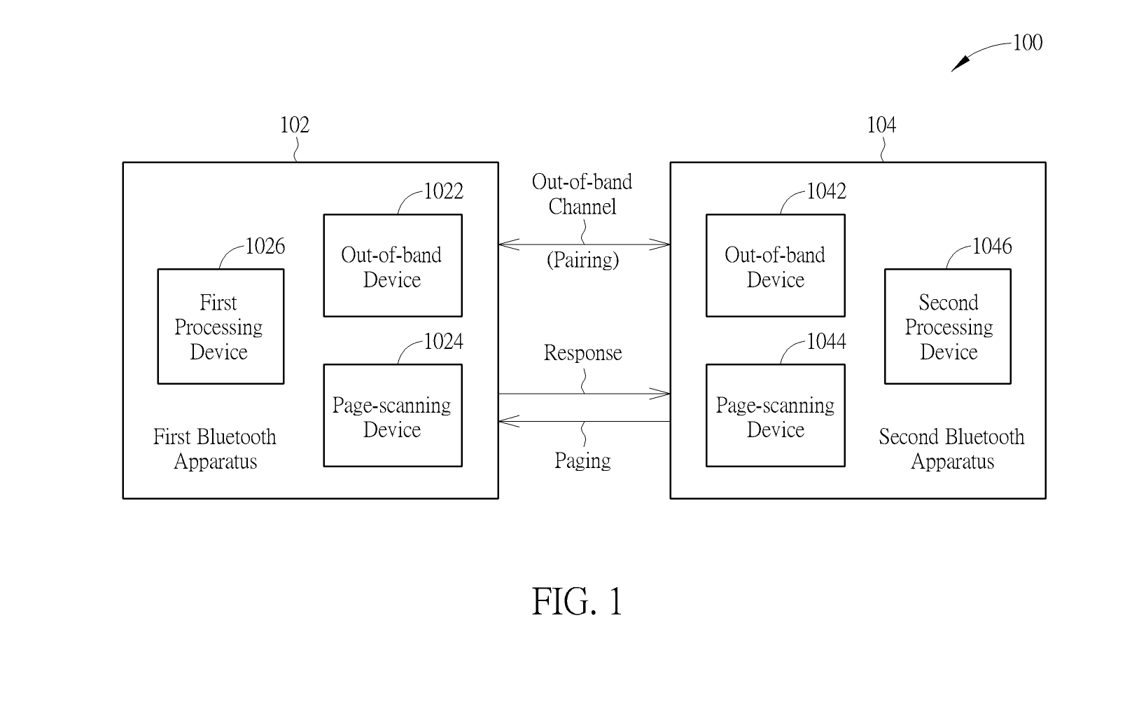

Please refer to FIG. 1, which is a diagram illustrating a Bluetooth system 100 having a first Bluetooth apparatus 102 and a second Bluetooth apparatus 104 according to a first embodiment of the present invention, wherein the second Bluetooth apparatus 104 is arranged to establish communications with the first Bluetooth apparatus 102. Thus, the first Bluetooth apparatus 102 is a slave Bluetooth device and the second Bluetooth apparatus 104 is a master Bluetooth device. It should be noted that there may be more than one slave Bluetooth device in the vicinity of the master Bluetooth device; however, for brevity, only one slave Bluetooth device is shown in FIG. 1. According to the embodiment of the invention, the first Bluetooth apparatus 102 comprises an out-of-band device 1022, a page-scanning device 1024, and a first processing device 1026. The out-of-band device 1022 is arranged to use an out-of-band channel to pair with the second Bluetooth apparatus 104 (i.e. the master Bluetooth apparatus) when the second Bluetooth apparatus 104 intends to pair with the first Bluetooth apparatus 102 (i.e. the slave Bluetooth apparatus). The page-scanning device 1024 is arranged to enable an enhanced page-scanning mechanism to scan a channel used by the second Bluetooth apparatus 104 for transmitting an ID (identifier) packet of the second Bluetooth apparatus 104 when the first Bluetooth apparatus 102 is paired with the second Bluetooth apparatus 104 via the out-of-band channel. The first processing device 1026 is arranged to process the data received from/transmit to the out-of-band device 1022 and/or the page-scanning device 1024. In addition, the second Bluetooth apparatus 104 comprises an out-of-band device 1042, a paging device 1044, and a second processing device 1046. The out-of-band device 1042 is arranged to use the out-of-band channel to pair with the first Bluetooth apparatus 102 (i.e. the slave Bluetooth apparatus). The paging device 1044 is arranged to transmit the ID packet to the first Bluetooth apparatus 102 when the first Bluetooth apparatus 102 is paired with the second Bluetooth apparatus 104 via the out-of-band channel. The second processing device 1046 is arranged to process the data received from/transmitted to the out-of-band device 1042 and/or the paging device 1044.

It should be noted that the enhanced page-scanning mechanism is different from a default Bluetooth page-scanning mechanism, in which the enhanced page-scanning mechanism may be an aggressive page-scanning mechanism set/tuned/designed by a user during the chip designing process, and the default Bluetooth page-scanning mechanism may be a predetermined Bluetooth page-scanning mechanism defined in the Bluetooth specifications. Normally, a slave Bluetooth device periodically enters the page-scanning state to scan the channel used by a master Bluetooth device for transmitting an ID packet. Two parameters—the inquiry scan interval and the inquiry scan window—are used to determine how frequently the slave Bluetooth device enters the page-scanning state and how much time the slave Bluetooth device spends there. In the default Bluetooth page-scanning mechanism, the default inquiry scan interval is 2.56 s, and the default inquiry scan window is 11.25 ms. More specifically, after the slave Bluetooth device is paired with the master Bluetooth device, the slave Bluetooth device may need to know the channel used by the master Bluetooth device for transmitting the ID packet. Then, the slave Bluetooth device randomly selects one of 32 channels, and scans the selected channel for 11.25 ms (i.e. the default inquiry scan window). If the slave Bluetooth device fails to determine/match the channel used by the master Bluetooth device within the default inquiry scan window 11.25 ms, the slave Bluetooth device may need to wait for 2.56 s (i.e. the default inquiry scan interval) to re-start another page-scanning process by using another channel.

The enhanced page-scanning mechanism of the present invention is different from the above-mentioned default Bluetooth page-scanning mechanism. More specifically, in one embodiment of the present invention, the present slave Bluetooth device (e.g. the first Bluetooth apparatus 102) is arranged to use an interlaced inquiry scan to scan the channel used by the master Bluetooth device (e.g. the second Bluetooth apparatus 104) for transmitting the ID packet of the master Bluetooth device.

In another embodiment of the present invention, the present slave Bluetooth device (e.g. the first Bluetooth apparatus 102) is arranged to shorten the inquiry scan interval of the slave Bluetooth device to re-scan the channel if the slave Bluetooth device fails to determine/match the channel used by the master Bluetooth device (e.g. the second Bluetooth apparatus 104) for transmitting the ID packet of the master Bluetooth device.

In addition, in another embodiment of the present invention, the present slave Bluetooth device (e.g. the first Bluetooth apparatus 102) is arranged to retrieve a clock information used by the master Bluetooth device (e.g. the second Bluetooth apparatus 104) to page the slave Bluetooth device, and then the present slave Bluetooth device is arranged to determine the target channel according to the clock information during the page-scanning process.

It should be noted that the above-mentioned three enhanced page-scanning methods may all be incorporated into a single Bluetooth device or independently installed into three Bluetooth devices respectively, or any combinations of the three enhanced page-scanning methods may also be incorporated into a single Bluetooth device. According to the present invention, even when only one of the three enhanced page-scanning methods is applied in a Bluetooth device, the Bluetooth device can establish communications with another Bluetooth device faster than a Bluetooth device using the conventional method.

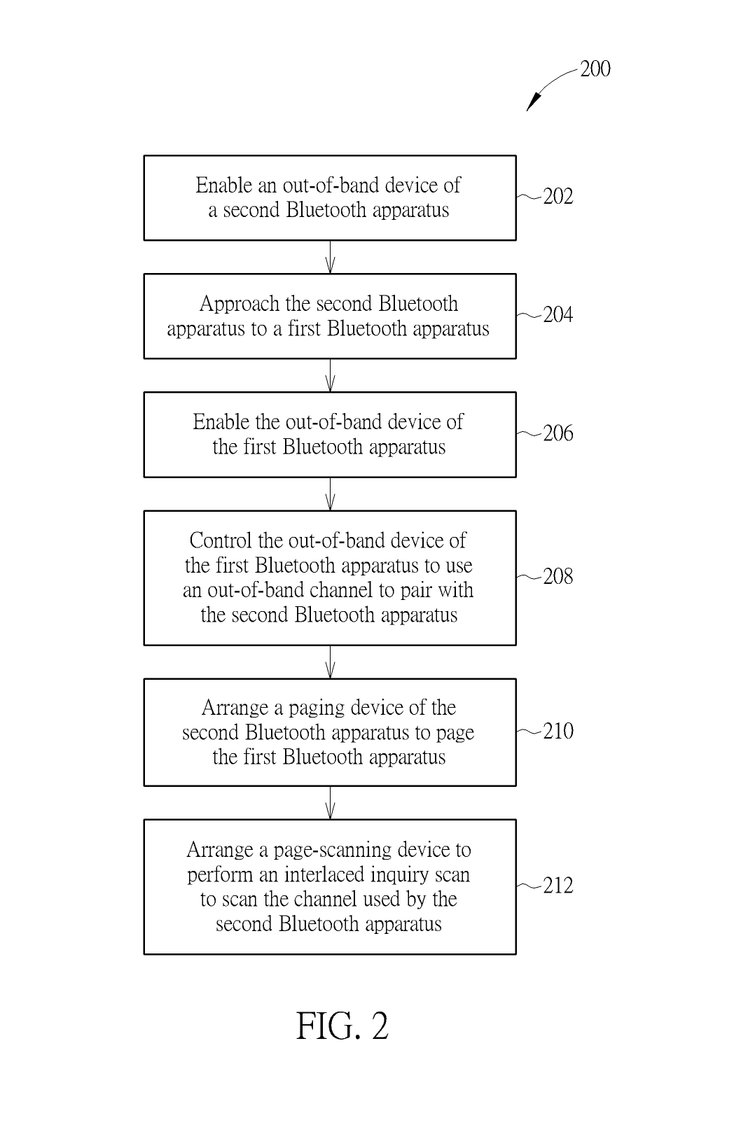

Please refer to FIG. 2, which is a flowchart illustrating a communications establishing method 200 for the first Bluetooth apparatus 102 and the second Bluetooth apparatus 104 according to a second embodiment of the present invention. Provided that substantially the same result is achieved, the steps of the flowchart shown in FIG. 2 need not be in the exact order shown and need not be contiguous; that is, other steps can be intermediate.

The communications establishing method 200 comprises:

Step 202: Enable the out-of-band device 1042 of the second Bluetooth apparatus 104;

Step 204: Place the second Bluetooth apparatus 104 in range of the first Bluetooth apparatus 102;

Step 206: Enable the out-of-band device 1022 of the first Bluetooth apparatus 102;

Step 208: Control the out-of-band device 1022 of the first Bluetooth apparatus 102 to use an out-of-band channel to pair with the second Bluetooth apparatus 104 when the second Bluetooth apparatus 104 intends to pair with the first Bluetooth apparatus 102 by using the out-of-band channel;

Step 210: Arrange the paging device 1044 of the second Bluetooth apparatus 104 to page (i.e. to transmit the ID packet) to the first Bluetooth apparatus 102 when the first Bluetooth apparatus 102 is paired with the second Bluetooth apparatus 104 via the out-of-band channel;

Step 212: Arrange the page-scanning device 1024 to perform an interlaced inquiry scan to scan the channel used by the paging device 1044 of the second Bluetooth apparatus 104 for transmitting the ID packet.

In this embodiment, the page-scanning device 1024 of the first Bluetooth apparatus 102 may further comprise an inquiry scanning unit arranged to perform the interlaced inquiry scan to scan the channel used by the second Bluetooth apparatus 104 for transmitting the ID packet. This is not a limitation of the present invention. The operation of the out-of-band device 1022 and the page-scanning device 1024 may also be implemented with a control codeword driven by a controller.

When a user intends to pair the second Bluetooth apparatus 104 with the first Bluetooth apparatus 102, the user may first manually or automatically enable the out-of-band device 1042 of the second Bluetooth apparatus 104 (step 202), and then move the second Bluetooth apparatus 104 towards the first Bluetooth apparatus 102 (step 204). Then, the out-of-band device 1022 of the first Bluetooth apparatus 102 is manually or automatically enabled to detect an out-of-band channel (step 206). It is noted that, by detecting the out-of-band channel, the first Bluetooth apparatus 102 will know a device wishes to pair with the first Bluetooth apparatus 102. Then, in step 208, the out-of-band device 1022 of the first Bluetooth apparatus 102 uses the out-of-band channel to pair with the second Bluetooth apparatus 104 when the second Bluetooth apparatus 104 is close enough to the first Bluetooth apparatus 102.

When the first Bluetooth apparatus 102 is paired with the second Bluetooth apparatus 104 via the out-of-band channel, the paging device 1044 of the second Bluetooth apparatus 104 is arranged to page (i.e. to transmit the ID packet) to the first Bluetooth apparatus 102 (step 210). Meanwhile, the page-scanning device 1024 of the first Bluetooth apparatus 102 is arranged to perform the interlaced inquiry scan to scan the channel used by the paging device 1044 of the second Bluetooth apparatus 104 for transmitting the ID packet (step 212).

More specifically, when the first Bluetooth apparatus 102 enters the interlaced inquiry scanning mode, the page-scanning device 1024 of the first Bluetooth apparatus 102 scans a channel in A Train, which comprises 16 channels out of the 32 channels, for 11.25 ms, and immediately switches to scan a channel in B Train, which comprises the other 16 channels out of the 32 channels, for 11.25 ms if the first Bluetooth apparatus 102 fails to determine the channel used by the second Bluetooth apparatus 104 for transmitting the ID packet in A Train. Therefore, by interlaced scanning of the A Train and B Train, the first Bluetooth apparatus 102 is almost ensured to hit the target channel of the second Bluetooth apparatus 104 in the first scanning trial because the second Bluetooth apparatus 104 is normally arranged to alternately use the A Train to page the first Bluetooth apparatus 102 for 10 ms and use the B Train to page the first Bluetooth apparatus 102 for another 10 ms. When the first Bluetooth apparatus 102 determines the target channel of the second Bluetooth apparatus 104, the first Bluetooth apparatus 102 transmits a response to the second Bluetooth apparatus 104 for ending the pairing process and for indicating the communications establishment between the first Bluetooth apparatus 102 and the second Bluetooth apparatus 104 is successful. It should be noted that the interlaced inquiry scan mode is usually disabled, but the interlaced inquiry scan mode is enabled once the out-of-band device 1022 is enabled.

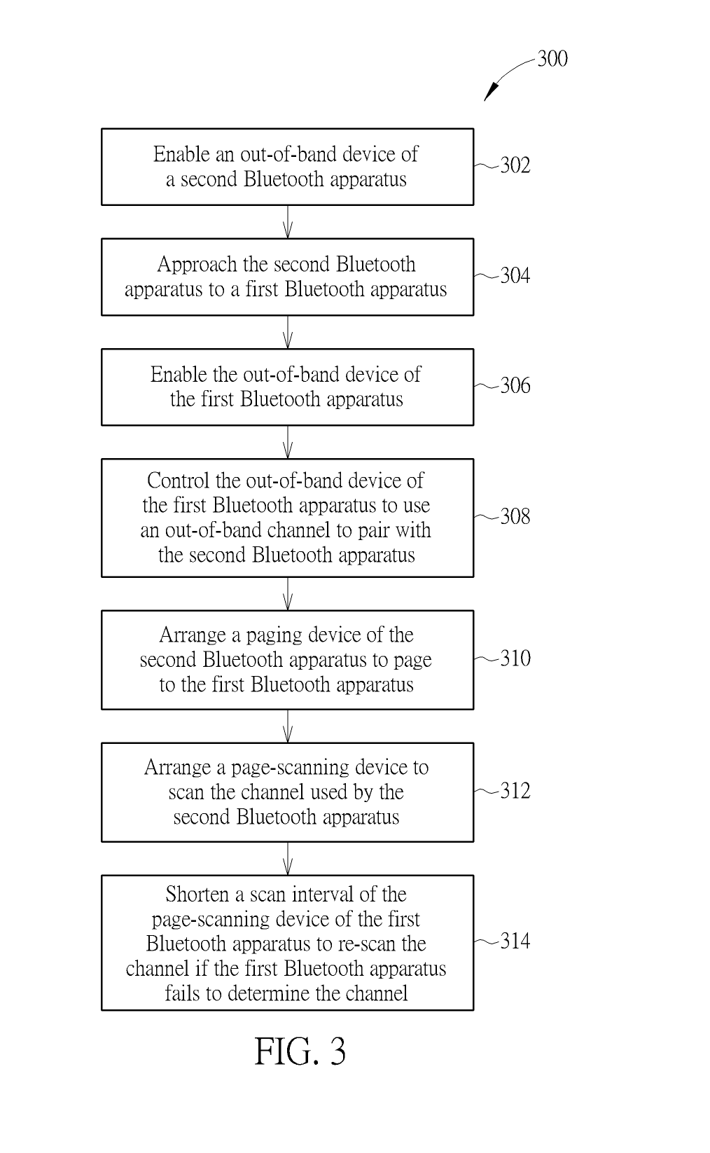

Please refer to FIG. 3, which is a flowchart illustrating a communications establishing method 300 for the first Bluetooth apparatus 102 and the second Bluetooth apparatus 104 according to a third embodiment of the present invention. Provided that substantially the same result is achieved, the steps of the flowchart shown in FIG. 3 need not be in the exact order shown and need not be contiguous; that is, other steps can be intermediate.

The communications establishing method 300 comprises:

Step 302: Enable the out-of-band device 1042 of the second Bluetooth apparatus 104;

Step 304: Place the second Bluetooth apparatus 104 in range of the first Bluetooth apparatus 102;

Step 306: Enable the out-of-band device 1022 of the first Bluetooth apparatus 102;

Step 308: Control the out-of-band device 1022 of the first Bluetooth apparatus 102 to use an out-of-band channel to pair with the second Bluetooth apparatus 104 when the second Bluetooth apparatus 104 intends to pair with the first Bluetooth apparatus 102 by using the out-of-band channel;

Step 310: Arrange the paging device 1044 of the second Bluetooth apparatus 104 to page (i.e. to transmit the ID packet) to the first Bluetooth apparatus 102 when the first Bluetooth apparatus 102 is paired with the second Bluetooth apparatus 104 via the out-of-band channel;

Step 312: Arrange the page-scanning device 1024 to scan the channel used by the paging device 1044 of the second Bluetooth apparatus 104 for transmitting the ID packet;

Step 314: Shorten a scan interval of the page-scanning device 1024 of the first Bluetooth apparatus 102 to re-scan the channel if the first Bluetooth apparatus 102 fails to determine the channel used by the paging device 1044 of the second Bluetooth apparatus 104.

In this embodiment, the page-scanning device 1024 of the first Bluetooth apparatus 102 may further comprise an adjusting unit arranged to shorten a scan interval to re-scan the channel if the page-scanning device 1024 fails to determine the channel used by the paging device 1044 of the second Bluetooth apparatus 104 for transmitting the ID packet. More specifically, the adjusting unit may comprise: a setting unit arranged to set a shortest scan interval acceptable for a Bluetooth system as the scan interval; a counter arranged to count the shortest scan interval for delaying the page-scanning device 1024 if the page-scanning device 1024 fails to determine the channel in a page scanning operation; and a controller arranged to control the page-scanning device 1024 to re-scan the channel after the shortest scan interval. This is not a limitation of the present invention. The operation of the out-of-band device 1022 and the page-scanning device 1024 (i.e. the setting unit, the counter, and the controller) may also be implemented by a control codeword driven by a controller.

When a user intends to pair the second Bluetooth apparatus 104 with the first Bluetooth apparatus 102, the user may first manually or automatically enable the out-of-band device 1042 of the second Bluetooth apparatus 104 (step 302), and then move the second Bluetooth apparatus 104 towards the first Bluetooth apparatus 102 (step 304). Then, the out-of-band device 1022 of the first Bluetooth apparatus 102 is manually or automatically enabled to detect an out-of-band channel (step 306). It is noted that, by detecting the out-of-band channel, the first Bluetooth apparatus 102 is able to know a device wishes to pair with the first Bluetooth apparatus 102. Then, in step 308, the out-of-band device 1022 of the first Bluetooth apparatus 102 uses the out-of-band channel to pair with the second Bluetooth apparatus 104 when the second Bluetooth apparatus 104 is close enough to the first Bluetooth apparatus 102.

When the first Bluetooth apparatus 102 is paired with the second Bluetooth apparatus 104 via the out-of-band channel, the paging device 1044 of the second Bluetooth apparatus 104 is arranged to page (i.e. to transmit the ID packet) to the first Bluetooth apparatus 102 (step 310). Meanwhile, the page-scanning device 1024 of the first Bluetooth apparatus 102 is arranged to perform a default/normal page scanning procedure or the above-mentioned interlaced inquiry scan to scan the channel used by the paging device 1044 of the second Bluetooth apparatus 104 for transmitting the ID packet (step 312).

If the page-scanning device 1024 of the first Bluetooth apparatus 102 fails to determine the channel used by the paging device 1044 of the second Bluetooth apparatus 104 during the first trial by using the default/normal page scanning procedure or the above-mentioned interlaced inquiry scan, the page-scanning device 1024 of the first Bluetooth apparatus 102 needs to re-scan the channel. Then, the page-scanning device 1024 of the first Bluetooth apparatus 102 will wait for the scan interval before re-scanning the channel. In this embodiment, the scan interval is set to be the shortest scan interval acceptable for a Bluetooth system. For example, the shortest scan interval may be set as 25 ms. Therefore, when the scan interval of the first Bluetooth apparatus 102 is reduced into the shortest scan interval acceptable for the Bluetooth system, the first Bluetooth apparatus 102 can determine the target channel of the second Bluetooth apparatus 104 in a very short time. By using the communications establishing method 300, the first Bluetooth apparatus 102 may consume higher power than the conventional counter part because the number of times to re-scan the channel may increase. According to the present invention, a power consumed by the first Bluetooth apparatus 102 when the enhanced page-scanning mechanism (i.e. the communications establishing method 300) is enabled will be higher than the power consumed by the first Bluetooth apparatus 102 when the default Bluetooth page-scanning mechanism is enabled.

When the first Bluetooth apparatus 102 determines the target channel of the second Bluetooth apparatus 104, the first Bluetooth apparatus 102 transmits a response to the second Bluetooth apparatus 104 for ending the pairing process and for indicating the communications establishment between the first Bluetooth apparatus 102 and the second Bluetooth apparatus 104 is successful.

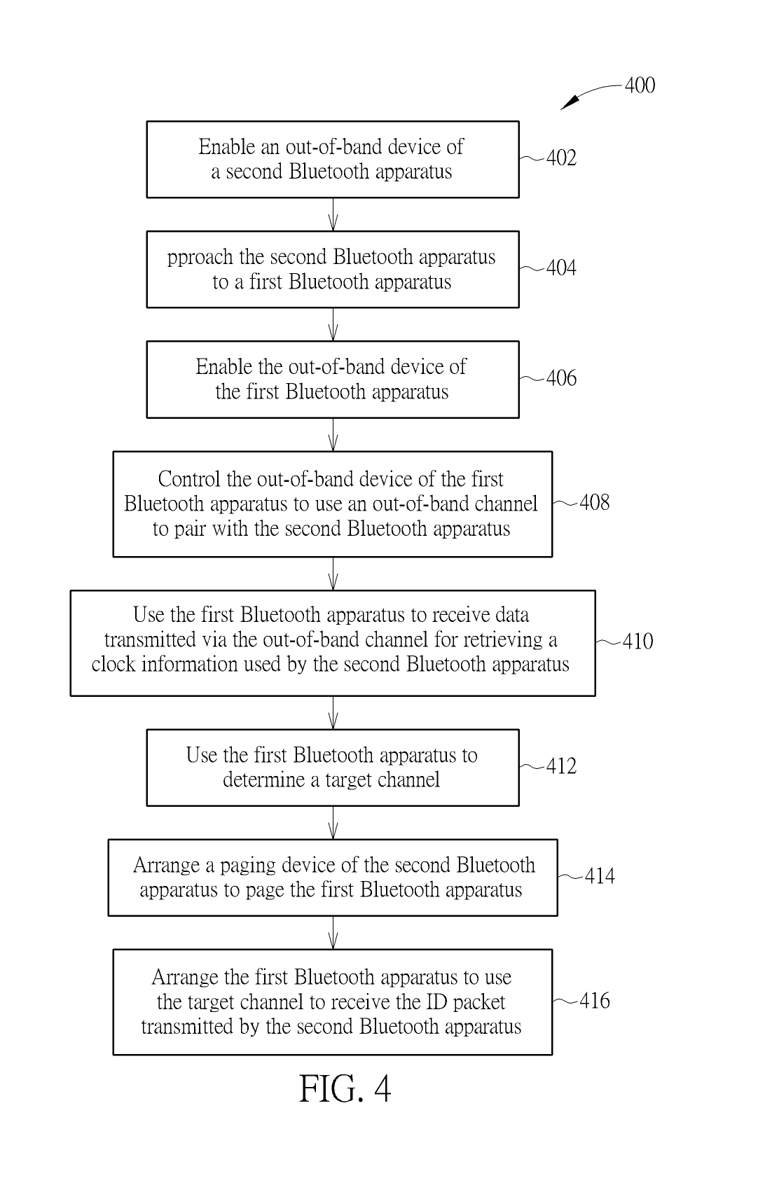

Please refer to FIG. 4, which is a flowchart illustrating a communications establishing method 400 for the first Bluetooth apparatus 102 and the second Bluetooth apparatus 104 according to a fourth embodiment of the present invention. Provided that substantially the same result is achieved, the steps of the flowchart shown in FIG. 4 need not be in the exact order shown and need not be contiguous; that is, other steps can be intermediate.

The communications establishing method 400 comprises:

Step 402: Enable the out-of-band device 1042 of the second Bluetooth apparatus 104;

Step 404: Place the second Bluetooth apparatus 104 in range of the first Bluetooth apparatus 102;

Step 406: Enable the out-of-band device 1022 of the first Bluetooth apparatus 102;

Step 408: Control the out-of-band device 1022 of the first Bluetooth apparatus 102 to use an out-of-band channel to pair with the second Bluetooth apparatus 104 when the second Bluetooth apparatus 104 intends to pair with the first Bluetooth apparatus 102 by using the out-of-band channel;

Step 410: Use the first Bluetooth apparatus 102 to receive data transmitted via the out-of-band channel for retrieving clock information used by the second Bluetooth apparatus 104 for paging the first Bluetooth apparatus 102;

Step 412: Use the first Bluetooth apparatus 102 to determine a target channel according to the clock information;

Step 414: Arrange the paging device 1044 of the second Bluetooth apparatus 104 to page (i.e. to transmit the ID packet) to the first Bluetooth apparatus 102 when the first Bluetooth apparatus 102 is paired with the second Bluetooth apparatus 104 via the out-of-band channel;

Step 416: Arrange the first Bluetooth apparatus 102 to use the target channel to receive the ID packet transmitted by the second Bluetooth apparatus 104.

Accordingly, in this embodiment, the out-of-band device 1022 of the first Bluetooth apparatus 102 may also be used to receive data transmitted via the out-of-band channel for retrieving the clock information used by the second Bluetooth apparatus 104 to page the first Bluetooth apparatus 102. Moreover, the page-scanning device 1024 may comprise a determining unit arranged to determine the target channel according to the clock information, and the page-scanning device 1024 uses the target channel to receive the ID packet transmitted by the second Bluetooth apparatus 104. This is not a limitation of the present invention. The operation of the out-of-band device 1022 and the page-scanning device 1024 (i.e. the determining unit) may also be implemented by a control codeword driven by a controller.

When a user intends to pair the second Bluetooth apparatus 104 with the first Bluetooth apparatus 102, the user may first manually or automatically enable the out-of-band device 1042 of the second Bluetooth apparatus 104 (step 402), and then move the second Bluetooth apparatus 104 towards the first Bluetooth apparatus 102 (step 404). Then, the out-of-band device 1022 of the first Bluetooth apparatus 102 is manually or automatically enabled to detect an out-of-band channel (step 406). It is noted that, by detecting the out-of-band channel, the first Bluetooth apparatus 102 is able to know a device wishes to pair with the first Bluetooth apparatus 102. Then, in step 408, the out-of-band device 1022 of the first Bluetooth apparatus 102 uses the out-of-band channel to pair with the second Bluetooth apparatus 104 when the second Bluetooth apparatus 104 is close enough to the first Bluetooth apparatus 102. Moreover, in this embodiment, the out-of-band channel is not only used for pairing, but the first Bluetooth apparatus 102 is also arranged to receive data transmitted via the out-of-band channel for retrieving the clock information used by the second Bluetooth apparatus 104 for paging the first Bluetooth apparatus 102 in step 414 (step 410). Then, in step 412, the first Bluetooth apparatus 102 determine the target channel to be used by the second Bluetooth apparatus 104 for paging the first Bluetooth apparatus 102 in step 414 according to the clock information.

When the first Bluetooth apparatus 102 is paired with the second Bluetooth apparatus 104 via the out-of-band channel, the paging device 1044 of the second Bluetooth apparatus 104 is arranged to page (i.e. to transmit the ID packet using the target channel) to the first Bluetooth apparatus 102 (step 414). As the target channel used to page the first Bluetooth apparatus 102 is already known by the first Bluetooth apparatus 102, the page-scanning device 1024 of the first Bluetooth apparatus 102 just uses the default/normal page scanning procedure or the above-mentioned interlaced inquiry scan to scan for the target channel used by the paging device 1044 of the second Bluetooth apparatus 104 for transmitting the ID packet (step 416). Therefore, the page-scanning device 1024 of the first Bluetooth apparatus 102 is able to hit the target channel of the second Bluetooth apparatus 104 in the first scanning trial because the target channel used by the second Bluetooth apparatus 104 is already known by the first Bluetooth apparatus 102.

When the first Bluetooth apparatus 102 determines the target channel of the second Bluetooth apparatus 104, the first Bluetooth apparatus 102 transmits a response to the second Bluetooth apparatus 104 for ending the pairing process and for indicating the communications establishment between the first Bluetooth apparatus 102 and the second Bluetooth apparatus 104 is successful.

It should be noted that, in the above-mentioned fourth embodiment, the determining unit is not limited to determine the target channel according to the clock information. In a fifth embodiment, the determining unit may used to determine a target train (i.e. the A Train or the B Train) used by the second Bluetooth apparatus 104 for transmitting the ID packet of the second Bluetooth apparatus 104 according to the clock information. Therefore, in the fifth embodiment, the page-scanning device 1024 is arranged to use the default/normal page scanning procedure or the above-mentioned interlaced inquiry scan to scan for a specific channel in the target train to receive the ID packet transmitted by the second Bluetooth apparatus 104. Therefore, the page-scanning device 1024 of the first Bluetooth apparatus 102 is able to hit the target channel of the second Bluetooth apparatus 104 in the first scanning trial because the target train used by the second Bluetooth apparatus 104 is already known by the first Bluetooth apparatus 102.

In addition, in the above-mentioned embodiments, the out-of-band device 1022 (1042) may be a Near Field Communications (NFC) device, and the out-of-band channel is a channel used by the NFC device. This is not a limitation of the present invention. The out-of-band device 1022 (1042) may also be implemented by an accelerometer or a proximity sensor, and the out-of-band channel is a channel used by an accelerometer or a proximity sensor. Moreover, the out-of-band device 1022 (e.g. the NFC device) may be controlled by a control unit in the first Bluetooth apparatus 102, and the control unit is arranged to enable the NFC device when the second Bluetooth apparatus 104 intends to pair with the first Bluetooth apparatus 102.

It should be noted that the above-mentioned three enhanced page-scanning embodiments (i.e. communications establishing methods 200, 300, 400) can also be modified for a single slave Bluetooth device. Those skilled in the art should understand how to modify the invention appropriately after reading the disclosure of the above-mentioned three enhanced page-scanning embodiments. Moreover, if the above-mentioned three enhanced page-scanning embodiments are applied into a single slave Bluetooth device, the communications establishing between the slave Bluetooth device and a master Bluetooth device could be done in 100 ms.

Briefly, according to the present invention, the present Bluetooth device first uses the out-of-band channel to pair with the other Bluetooth device, and then uses the enhanced page-scanning method to scan the page of the other Bluetooth device. By doing this, the present Bluetooth device is capable of establishing communications with the other Bluetooth device more efficiently and faster than in the conventional method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communications establishing method for a Bluetooth system, comprising:
setting a first Bluetooth apparatus to use an out-of-band channel to pair with a second Bluetooth apparatus when the second Bluetooth apparatus intends to pair with the first Bluetooth apparatus; and
enabling an enhanced page-scanning mechanism in the first Bluetooth apparatus to scan a channel used by the second Bluetooth apparatus for transmitting an ID packet of the second Bluetooth apparatus when the first Bluetooth apparatus is paired with the second Bluetooth apparatus via the out-of-band channel.

2. The communications establishing method of claim 1, wherein the step of enabling the enhanced page-scanning mechanism in the first Bluetooth apparatus to scan the channel used by the second Bluetooth apparatus for transmitting the ID packet of the second Bluetooth apparatus when the first Bluetooth apparatus is paired with the second Bluetooth apparatus via the out-of-band channel comprises:
setting the first Bluetooth apparatus to use an interlaced inquiry scan to scan the channel used by the second Bluetooth apparatus for transmitting the ID packet of the second Bluetooth apparatus.

3. The communications establishing method of claim 1, wherein the step of enabling the enhanced page-scanning mechanism in the first Bluetooth apparatus to scan the channel used by the second Bluetooth apparatus for transmitting the ID packet of the second Bluetooth apparatus when the first Bluetooth apparatus is paired with the second Bluetooth apparatus via the out-of-band channel comprises:
shortening a scan interval of the first Bluetooth apparatus to re-scan the channel if the first Bluetooth apparatus fails to determine the channel used by the second Bluetooth apparatus for transmitting the ID packet of the second Bluetooth apparatus.

4. The communications establishing method of claim 3, wherein the step of shortening the scan interval of the first Bluetooth apparatus to re-scan the channel used by the second Bluetooth apparatus for transmitting the ID packet of the second Bluetooth apparatus if the first Bluetooth apparatus fails to determine the channel comprises:
setting a shortest scan interval acceptable for the Bluetooth system as the scan interval;
when the first Bluetooth apparatus fails to determine the channel in a page scanning operation, delaying the first Bluetooth apparatus for the shortest scan interval; and
using the first Bluetooth apparatus to re-scan the channel after the shortest scan interval.

5. The communications establishing method of claim 1, further comprising:
using the first Bluetooth apparatus to receive data transmitted via the out-of-band channel for retrieving a clock information used by the second Bluetooth apparatus to page the first Bluetooth apparatus; and
the step of enabling the enhanced page-scanning mechanism in the first Bluetooth apparatus to scan the channel used by the second Bluetooth apparatus for transmitting the ID packet of the second Bluetooth apparatus when the first Bluetooth apparatus is paired with the second Bluetooth apparatus via the out-of-band channel comprises:
using the first Bluetooth apparatus to determine a target channel according to the clock information; and
setting the first Bluetooth apparatus to use the target channel to receive the ID packet transmitted by the second Bluetooth apparatus.

6. The communications establishing method of claim 1, further comprising:
using the first Bluetooth apparatus to receive data transmitted via the out-of-band channel for retrieving a clock information used by the second Bluetooth apparatus to page the first Bluetooth apparatus; and
the step of enabling the enhanced page-scanning mechanism in the first Bluetooth apparatus to scan the channel used by the second Bluetooth apparatus for transmitting the ID packet of the second Bluetooth apparatus when the first Bluetooth apparatus is paired with the second Bluetooth apparatus via the out-of-band channel comprises:
using the first Bluetooth apparatus to determine a target train used by the second Bluetooth apparatus for transmitting the ID packet of the second Bluetooth apparatus according to the clock information; and
setting the first Bluetooth apparatus to use a specific channel in the target train to receive the ID packet transmitted by the second Bluetooth apparatus.

7. The communications establishing method of claim 1, wherein the out-of-band channel is a channel used by a Near Field Communications (NFC) device.

8. The communications establishing method of claim 1, wherein the out-of-band channel is a channel used by an accelerometer or a proximity sensor.

9. The communications establishing method of claim 1, further comprising:
enabling a Near Field Communications (NFC) device in the first Bluetooth apparatus when the second Bluetooth apparatus intends to pair with the first Bluetooth apparatus.

10. A Bluetooth apparatus, comprising:
an out-of-band device, arranged to use an out-of-band channel to pair with a specific Bluetooth apparatus when the specific Bluetooth apparatus intends to pair with the Bluetooth apparatus; and
a page-scanning device, arranged to enable an enhanced page-scanning mechanism to scan a channel used by the specific Bluetooth apparatus for transmitting an ID packet of the specific Bluetooth apparatus when the Bluetooth apparatus is paired with the specific Bluetooth apparatus via the out-of-band channel.

11. The Bluetooth apparatus of claim 10, wherein the page-scanning device comprises:
an inquiry scanning unit, arranged to perform an interlaced inquiry scan to scan the channel used by the specific Bluetooth apparatus for transmitting the ID packet of the specific Bluetooth apparatus.

12. The Bluetooth apparatus of claim 10, wherein the page-scanning device comprises:
an adjusting unit, arranged to shorten a scan interval to re-scan the channel if the page-scanning device fails to determine the channel used by the specific Bluetooth apparatus for transmitting the ID packet of the specific Bluetooth apparatus.

13. The Bluetooth apparatus of claim 12, wherein the adjusting unit comprises:
a setting unit, arranged to set a shortest scan interval acceptable for a Bluetooth system as the scan interval;
a counter, arranged to count the scan interval for delaying the page-scanning device if the page-scanning device fails to determine the channel in a page scanning operation; and
a controller, arranged to control the page-scanning device to re-scan the channel after the scan interval.

14. The Bluetooth apparatus of claim 10, wherein the out-of-band device further receives data transmitted via the out-of-band channel for retrieving a clock information used by the specific Bluetooth apparatus to page the Bluetooth apparatus, and the page-scanning device comprises:
a determining unit, arranged to determine a target channel according to the clock information;
wherein the page-scanning device uses the target channel to receive the ID packet transmitted by the specific Bluetooth apparatus.

15. The Bluetooth apparatus of claim 10, wherein the out-of-band device further receives data transmitted via the out-of-band channel for retrieving a clock information used by the specific Bluetooth apparatus to page the Bluetooth apparatus; and the page-scanning device comprises:
a determining unit, arranged to determine a target train used by the specific Bluetooth apparatus for transmitting the ID packet of the specific Bluetooth apparatus according to the clock information;
wherein the page-scanning device uses a specific channel in the target train to receive the ID packet transmitted by the specific Bluetooth apparatus.

16. The Bluetooth apparatus of claim 10, wherein the out-of-band device is a Near Field Communications (NFC) device.

17. The Bluetooth apparatus of claim 10, wherein the out-of-band device is an accelerometer or a proximity sensor.

18. The Bluetooth apparatus of claim 10, wherein the out-of-band device is a Near Field Communications (NFC) device, and the Bluetooth apparatus further comprises:
a control unit, arranged to enable the NFC device when the specific Bluetooth apparatus intends to pair with the Bluetooth apparatus.
